(19) United States
(12) Patent Application Publication
(10) Pub. No.: US 2024/0159156 A1
(43) Pub. Date: May 16, 2024

(54) METHODS FOR CREATING A NICKEL STRIKE LAYER AND NICKEL ELECTROLYTIC BONDCOAT ONTO A NON-CONDUCTIVE CARBON FIBER COMPOSITE SURFACE AND THE COATING SYSTEM DERIVED THEREFROM

(71) Applicant: Kevin E. Garing, Indianapolis, IN (US)

(72) Inventor: Kevin E. Garing, Indianapolis, IN (US)

(21) Appl. No.: 18/490,886

(22) Filed: Oct. 20, 2023

Related U.S. Application Data
(60) Provisional application No. 63/383,163, filed on Nov. 10, 2022.

(51) Int. Cl. F01D 5/28; C25D 3/12; C25D 5/48; C25D 5/56

(52) U.S. Cl. CPC F01D 5/288; C25D 3/12; C25D 5/48; C25D 5/56; F01D 5/282; F05D 2230/31; F05D 2230/90; F05D 2240/303; F05D 2300/603; F05D 2300/611

(57) ABSTRACT

Novel methods for activating and electroplating a non-conductive carbon fiber composite part are provided. An exposed surface of the CFC part is mechanically activated followed by creating a relatively thin nickel strike layer in a controlled electrolytic process. A relatively thicker electrolytic nickel layer is deposited over the strike layer. The electrolytic nickel strike layer and electrolytic nickel layer serve as the foundation to enable deposition of any suitable erosion resistant coating thereon.

### RELATED APPLICATIONS

This application claims the benefit of priority from U.S. Serial Application No. 63/383,163 filed on Nov. 10, 2022, which is incorporated herein by reference in its entirety.

### FIELD OF THE INVENTION

The present invention generally relates to methods for modifying a non-conductive carbon fiber composite component and coatings derived therefrom to enable deposition of an erosion resistant coating system.

### BACKGROUND OF THE INVENTION

Development of small, lightweight autonomous flight vehicles is on-going with commercialization expected to occur within the next 10 years or less. The autonomous flight vehicles intend to utilize lightweight carbon fiber composite (CFC) rotor blades to reduce overall weight of the vehicle. One non-limiting example of a suitable material for CFC rotor blades is poly (ether-ketone-ketone), commonly known as PEEK in the industry.

A primary technical challenge of CFC rotor blades is the blades can be subject to significant erosion arising from exposure in the ambient environment to water droplets and dust attacking the surfaces of the CFC rotor blades. By way of example, a leading edge of the CFC rotor blade can be subject to erosion.

Several approaches have been attempted in the urban air mobility industry to reduce, suppress or entirely eliminate the erosion on the CFC rotor blades. For example, one approach has been application of thermal spray erosion resistant coatings directly onto a lead edge of the CFC rotor blade. Although thermal spray coatings can impart erosion resistance, thermal spray coatings must be applied at elevated temperatures (e.g., 200 deg F. or higher) that can damage the CFC material. However, many common CFC materials can be damaged by temperatures above 200 deg F. Additionally, the thickness of the thermal spray coating can exhibit unacceptable non-uniformity along the curvature of the lead edge of the blade. Moreover, relatively thick thermal spray coatings may be required to effectively absorb heat and prevent the underlying CFC rotor blade from overheating during operation. For at least these reasons, thermal spray coatings are not a viable solution.

Another approach for erosion resistance that has been evaluated is the fabrication of a metal sheath that can be fitted over the leading edge of the CFC rotor blade. However, such metal sheaths can significantly increase the weight of the blade. Moreover, the manufacturing process for forming a metal sheath with the requisite geometry to fit over the leading edge of the CFC rotor blade can be complex and not cost effective. Still further, because the source metal needs to be malleable and ductile in order to form the sheath covering, the usage of such types of metal can be more susceptible to erosion, thereby defeating the design objective of an erosion resistant material for the CFC rotor blade.

Given the drawbacks described hereinabove, there continues to be a need for improved methods and materials to reduce, suppress or entirely eliminate the erosion on CFC rotor blades.

### SUMMARY OF THE INVENTION

In a first aspect of the present invention, a method of modifying a carbon fiber composite (CFC) part to enable deposition of an erosion resistant coating system onto the CFC part, comprising: providing the CFC part; mechanically activating at least a portion of an exposed surface of the CFC part to create an activated surface; immersing the activated surface of the CFC part into a first nickel-plating bath composition, electroplating a nickel strike electrolytic layer onto the activated surface of the CFC part; removing the CFC part from the first nickel-plating bath composition; immersing the nickel strike electrolytic layer of the CFC part into a second nickel-plating bath composition; and electroplating a nickel electrolytic bondcoat onto the nickel strike electrolytic layer of the CFC part.

In a second aspect, a method of modifying a carbon fiber composite (CFC) part to enable deposition of an erosion resistant coating system onto the CFC part, comprising: providing the CFC part; mechanically activating at least a portion of an exposed surface of the CFC part to create an activated surface; immersing the activated surface of the CFC part into a nickel-plating bath composition; and electroplating a nickel strike electrolytic layer onto the activated surface of the CFC part.

In a third aspect, a modified carbon fiber composite (CFC) coated part, comprising: a CFC part; a nickel strike electrolytic layer on the CFC part; and a nickel electrolytic bondcoat overlying the nickel strike electrolytic layer.

The invention may include any of the aspects in various combinations and embodiments to be disclosed herein.

### BRIEF DESCRIPTION OF THE DRAWINGS

The objectives and advantages of the invention will be better understood from the following detailed description of the preferred embodiments thereof in connection with the accompanying figures wherein like numbers denote same features throughout and wherein:

FIG. 1 schematically depicts a nickel strike electrolytic layer, a nickel electrolytic bondcoat and an erosion resistant coating onto a CFC component, in accordance with the principles of the present invention;

FIG. 2 shows a photomicrograph of a nickel strike electrolytic layer and a nickel electrolytic bondcoat deposited onto a CFC part, in accordance with the principles of the present invention;

FIG. 3 is a representative plating tank for forming a nickel strike electrolytic layer on an activated and roughened surface of a CFC part, in accordance with the principles of the present invention;

FIG. 4 is a representative plating tank for forming a nickel electrolytic bondcoat onto a previously deposited nickel-strike electrolytic layer, in accordance with the principles of the present invention; and

FIG. 5 shows a representative schematic of a CFC rotor blade that may be utilized as part of an autonomous flight vehicle.

### DETAILED DESCRIPTION OF THE INVENTION

The advantages of the invention will be better understood from the following detailed description of the embodiments thereof in connection. The disclosure is set out herein in various embodiments and with reference to various features, aspects and embodiments of the invention, each of which may be employed in various permutations and combinations without departing from the scope of the invention. The disclosure may further be specified as comprising, consisting or consisting essentially of, any of such permutations and combinations of these specific features, aspects, and embodiments, or a selected one or ones thereof.

The drawings are for the purpose of illustrating the invention and are not intended to be drawn to scale. The embodiments are described with reference to the drawings in which similar elements are referred to by like numerals. Certain features are intentionally omitted in each of the drawings to better illustrate various aspects of the present invention, in accordance with the principles of the present invention. The embodiments as described below are by way of example only, and the invention is not limited to the embodiments illustrated in the drawings.

The terms “sufficiently”, “adequately”, “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Various aspects of the present invention may be presented in range format. Where a range of values describes a parameter, all sub-ranges, point values and endpoints within that range or defining a range are explicitly disclosed therein, unless explicitly disclosed otherwise. The parameter may include, but is not limited to, physical properties, dimensions, concentrations, operating parameters and process conditions. For example, description of a range such as from 1 to 10 shall be considered to have specifically disclosed sub-ranges such as from 1 to 7, from 2 to 9, from 7 to 10 and so on, as well as individual numbers within that sub-range such as 1, 5.3 and 9, respectively.

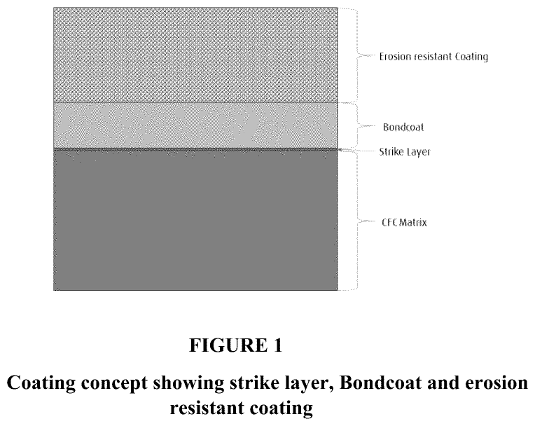

In one aspect of the present invention, methods of modifying a carbon fiber composite (CFC) part are provided to enable deposition of an erosion resistant coating system onto the CFC part. The result is the coating system shown in FIG. 1. A relatively thin electrolytic nickel strike layer is applied onto a pretreated surface of the CFC part that has been activated. A relatively thicker nickel electrolytic bondcoat is applied onto the electrolytic nickel strike layer. The sequential combination of these 2 types of nickel layers enables any suitable erosion resistant coating to be applied over the nickel electrolytic bondcoat.

The present invention involves a preliminary step of mechanically activating at least a portion of an exposed surface of the CFC part to create an activated surface. Preferably, the mechanical activation involves grit blasting with particulates ranging in size from about 220 mesh aluminum oxide at a pressure ranging from about 7-10 PSI. The grit blast step is a notable departure from the grit blast process for producing an adherent composite plating or thermal spray coating that is typically utilizing a coarser particle size of 60-120 mesh aluminum oxide at higher pressures above 40 PSI. The present invention deliberately utilizes a lighter grit blast with finer particles to avoid damage, roughening and/or stock loss of the CFC material. Applicants noted that initial grit blasting with particulates having a mesh size of 220 or coarser or any suitable size grit at pressures of 15-20 psi resulted in damage of the CFC surface. The relatively less intensive grit blast creates the necessary surface activation without imparting surface damage. It should be understood that other types of activation can be utilized, including, but not limited to, thermal or chemical activation. Further, it should be understood that chemical, thermal and mechanical processes for activation can be used singularly or in any combination to sufficiently create the requisite roughened surface of the CFC part without imparting damage to the CFC surface.

After mechanical activation of the CFC surface, the CFC surface is subject to a pretreatment step. The CFC surface is preferably rinsed with deionized water for a prescribed duration followed by an acid soak for a predetermined duration (e.g., 1 minute) to remove any impurities and/or grit blast residual debris remaining on the mechanically roughened surface. In a preferred embodiment, the acid is a 50 vol % solution of standard grade 33 vol % HCl, with the balance deionized water. The acid soak preferably occurs at room temperature (e.g., 60-75 deg F.) and for a predetermined duration (e.g., 5 minutes). The acid soak pretreatment chemically reacts or etches with the surface of the CFC test specimen to make the subsequently electrolytic nickel deposition more receptive to its adherence thereon.

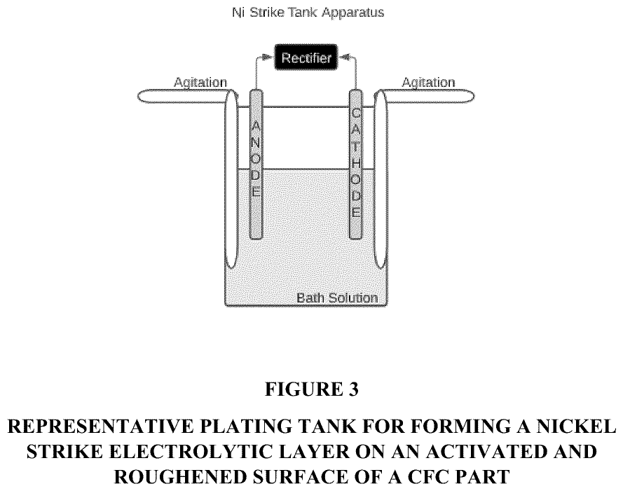

Having cleaned and pretreated the roughened surface of the CFC part, electroplating a nickel strike electrolytic layer can begin. The CFC part is operably connected to a plating fixture as shown in FIG. 3. FIG. 3 shows an exemplary plating tank that can be utilized in forming a nickel strike electrolytic layer onto the activated CFC part. The plating tank comprises a nickel-plating electrolyte solution. The nickel-plating electrolyte solution has a nickel-containing salt solution and a hydrogen-containing acid solution, both of which are dissolved in deionized water. In one non-limiting example, the nickel-containing salt solution is nickel chloride, and the hydrogen-containing acid solution is hydrochloric acid. As will be explained below, such formulation enables a relatively thin, adequately adherent nickel strike electrolytic layer to be electroplated in a controlled manner, whereby complete coverage of the CFC surface can be achieved with minimal thickness.

A direct current rectifier is utilized as the power source. Suitable anodes are shown immersed in the electrolyte solution. Anodes are connected to the positive side of the rectifier. The CFC part is connected to the negative side of the rectifier and immersed in the nickel-plating electrolyte solution. In operation, the rectifier is turned on to generate the requisite potential difference to create a current and current density. The voltage may range from 2.25 volts or higher and the current density may range from 40 Amps per square foot and higher. The criticality of the lower limit for the voltage and current density is based on Applicants' empirical determination that voltage below 2.25 volts and current density below 40 Amps per square foot does not effectively produce the nickel strike electrolytic layer.

The rectifier drives electron flow from the anodes to the CFC part. Electrons accumulate on the surface of the CFC part where they are available to react with positively charged nickel ions in the nickel-plating electrolyte solution. The positively charged nickel ions are reduced to elemental nickel, which deposits onto the exposed surface of the CFC part. Slight agitation of the electrolyte solution is preferably utilized to ensure nickel ions continue to remain in contact at the CFC part exposed surface. Agitation can occur in any suitable manner as known in the art, including, but not limited to mechanical stirring and air agitation.

The formation of the electrolytic nickel strike layer can occur in the absence of external heating. The temperature of the electroplating typically ranges from about 60-80 deg F. However, elevated temperatures may be beneficial in accelerating the strike layer growth.

As previously mentioned hereinabove, the nickel-plating electrolyte solution is deliberately formulated to have a higher concentration of acid content than a traditional bath solution because such an electrolyte composition promotes improved coverage and adhesion of the nickel strike layer onto the CFC part, while minimizing the overall thickness required to do so. Without being bound by any theory, during formation of the nickel strike electrolytic layer, both the nickel-containing salt solution and hydrogen-containing acid solution are competing with each other to react with the electrons that flow towards and onto the CFC part surface. These competing mechanisms are ongoing during formation of the nickel strike electrolytic layer. As electrons flow from the anode to the CFC surface, the electrons react with the positively charged nickel ions of the nickel-plating electrolyte solution, and also react with the hydrogen in the acid containing bath to liberate a significant amount of hydrogen gas at the CFC part surface. The net result is that the elemental nickel forms at a slower rate. Additionally, the liberation of hydrogen gas can enhance activation of the CFC exposed surface. Liberation of hydrogen gas occurs at an elevated rate due to the higher acid content when compared to a traditional bath. The hydrogen gas can scrub and clean the CFC surface during the electroplating, thereby increasing adherence of the elemental nickel that is deposited thereon. The scrubbing and cleaning can occur by micro-etching of the CFC surface. The hydrogen generation can be characterized as an in-situ cleaning and activation step of the CFC part surface, whereby any oxides or other contaminant species that can harm the adhesion of the elemental nickel atoms is removed during the nickel strike electrolytic process. In this manner, the competing reactions for electrons in the electroplating process can actually induce formation of a sufficiently adherent, nickel strike electrolytic layer that attains minimal thickness, but does so in a manner whereby maximum coverage of the exposed surface of the CFC part by the elemental nickel is achieved.

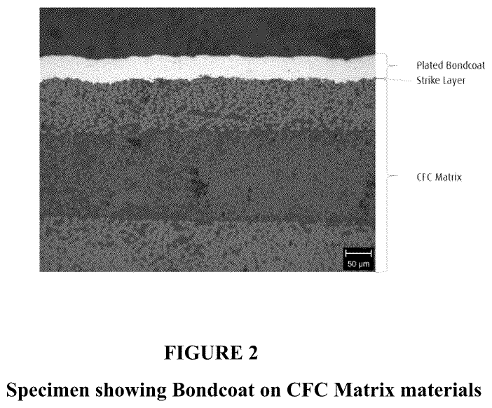

The resultant nickel strike electrolytic layer as representatively shown in FIGS. 1 and 2 is relatively thin in comparison to the overlying nickel electrolytic bondcoat that is subsequently electroplated thereon. By virtue of the higher current density required, the nickel-strike layer is a relatively stressed material. As a result, the nickel-strike electrolytic layer is intentionally created to not exceed a predetermined thickness, as increased thicknesses can elevate the risk that the nickel strike electrolytic layer spalls off from the CFC part due to excessive stresses created within the material and/or at the interface of the material and the CFC surface. In one non-limiting example, the nickel-strike layer is produced to have a minimal thickness to achieve full coverage of the surface, as shown in the photomicrograph of FIG. 2. In another non-limiting example, the maximum thickness is no greater than about 1 micron, preferably no greater than about 0.5 microns and more preferably no greater than about 0.2 microns.

In addition to the higher stresses, because the nickel strike electrolytic layer is brittle as a result of the relatively higher acid content of the nickel-plating electrolyte solution, the process is designed to create maximum coverage of the CFC part with a minimal thickness to avoid excessive brittleness of the nickel strike electrolytic layer. For these reasons, the present invention relies on maintaining a suitable minimally thin nickel electrolytic strike layer that is configured to remain on the CFC surface and not spall off due to brittleness or elevated stresses. The nickel strike electrolytic layer therefore can serve as an effective seed layer deposited directly onto the CFC part that allows subsequent electroplating of a relatively thicker nickel electrolytic bondcoat. In the absence of the nickel strike electrolytic layer, the nickel electrolytic bondcoat does not sufficiently adhere onto the CFC surface.

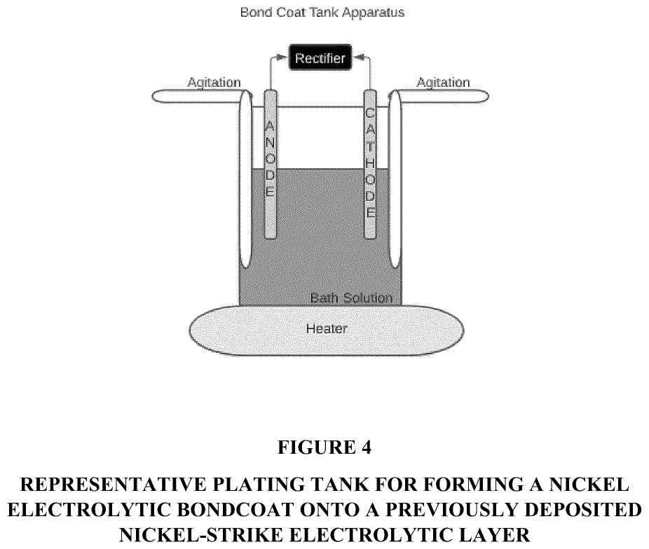

After formation of the required nickel strike electrolytic layer, the CFC part is withdrawn from the plating tank. The nickel electrolytic bondcoat layer can now be deposited onto the nickel strike electrolytic layer. The CFC part is connected to a second plating fixture utilized to perform the electroplating of the nickel electrolytic bondcoat onto the nickel strike electrolytic layer. FIG. 4 shows an exemplary plating tank for forming the nickel electrolytic bondcoat onto the nickel strike electrolytic layer. The plating tank comprises a second nickel-plating electrolyte solution that is different from the previous nickel-plating electrolyte solution for producing the nickel strike electrolytic layer. Additionally, a milder acidic electrolyte solution of the bath is utilized. The different chemical composition of the nickel-plating electrolyte solution allows build-up of plating thicknesses of several mils with a lower brittleness nickel electrolytic bondcoat than possible with the nickel strike electrolytic layer. In one non-limiting example, the second nickel-plating electrolyte solution comprises nickel sulfamate solution and boric acid, both of which are dissolved in deionized water. It should be understood that any other suitable nickel salt solution besides nickel sulfamate solution can be utilized which creates sufficiently low stress deposits of elemental nickel, and which can build-up with sufficient thickness, adhesion and ductility onto the nickel strike electrolytic layer.

A direct current rectifier is utilized as the power source. Suitable anodes are shown immersed in the electrolyte solution. The anodes are connected to the positive side of the rectifier. The CFC part is connected to the negative side of the rectifier and immersed in the second nickel-plating electrolyte solution. In operation, the rectifier is turned on to generate the requisite potential difference to create the current and current density. In comparison to the nickel strike electrolytic layer process, preferably a lower current density is utilized to form the nickel electrolytic bondcoat. In one example, the current density may range from 10 Amps per square foot, and higher. The lower current density allows a more ductile electrolytic nickel to be deposited. No external heating is utilized. Agitation of the second nickel-plating electrolyte solution is preferably utilized to ensure positively charged nickel ions continue to remain in contact with the CFC part exposed surface. Agitation can occur in any suitable manner as known in the art, including, but not limited to stir plates or bubblers.

With the rectifier powered on, electrons flow from the anode to the CFC part. As electrons flow from the anode to the CFC surface, the electrons react with the positively charged nickel ions of the nickel-plating electrolyte solution. In comparison to the nickel strike electrolytic layer, the presence of a more efficient electrolyte solution (i.e., more of the applied current deposits metal) can allow formation of the thicker elemental nickel electrolytic bondcoat in a controlled manner at a faster rate. The electroplating process can terminate after the required thickness of the nickel electrolytic bondcoat has been determined to have formed. Generally speaking, a longer plating time may be required to electroplate the required thickness of the nickel electrolytic bondcoat relative to the plating time required to electroplate a minimal thickness of the nickel strike electrolytic layer.

The resultant coating system is shown in FIGS. 1 and 2. By virtue of the lower current density and milder acidic bath, the nickel electrolytic bondcoat electrolytic layer is less stressed, more ductile and less brittle than the nickel strike electrolytic layer and therefore will adequately flex as the underlying CFC part flexes during its usage. Additionally, the thickness of the nickel electrolytic bondcoat is multiples greater than that of the nickel strike electrolytic layer. In one non-limiting example, the nickel electrolytic bondcoat has a thickness that is at least four times the thickness of the nickel strike electrolytic layer. The ability of the nickel electrolytic bondcoat to remain adequately adhered to the strike layer and remain ductile as the CFC part undergoes required flexibility allows any suitable erosion resistant coating to be applied thereon.

FIG. 1 shows an example of an erosion resistant coating system that can be deposited onto the nickel electrolytic bondcoat. The erosion resistant coating system can be formed by any known electrolytic or electroless process. By way of example, the erosion resistant coating can be applied as an entrapment electrolytic or electroless plating process where solid particulate is incorporated into the plating. Alternatively, the erosion resistant coating system may be a thermal spray coating, provided that the nickel electrolytic bondcoat is preferably deposited as a thicker layer than shown in FIG. 2 to ensure it can absorb the heat and protect the underlying CFC surface as a result of the higher temperatures (e.g., 200 deg F. or higher) utilized in thermal spray processes.

In a preferred embodiment of the present invention, the representative coating system as shown in the photomicrograph of FIG. 2 specifically excludes electroless methods in the creation of the nickel strike layer and overlying nickel plated bondcoat. Electroless methods are a chemical immersion process that generates its own current without employing an external rectifier. While Applicants recognize electroless methods are possible for creating a nickel strike layer and corresponding nickel plated bondcoat, the electroless nickel layer and nickel bondcoat do not render the performance characteristics of the present invention for CFC parts, and more preferably CFC rotor blades. Particularly, electroless nickel layers will have a tendency to incorporate residual salts from the plating solution, as it is a purely chemical immersion process that often requires building up several layers via multiple chemical immersion steps. On the contrary, electrolytic nickel-plating solutions tend to lead to plating of more pure elemental nickel layers. Hence, an electrolytic nickel layer as contemplated by the present invention will produce a higher purity nickel coating system. Additionally, multiple chemical immersion layers may be required to achieve a requisite “seed layer” onto which the nickel bondcoat can be plated onto, thereby increasing time of the process and complexity. However, chemical immersion may not be a consistently reliable method to attain full coverage. Still further, the adhesion of the thin film produced by chemical immersion is inadequate and not as strong as exhibited by nickel strike layers and nickel electrolytic bondcoats.

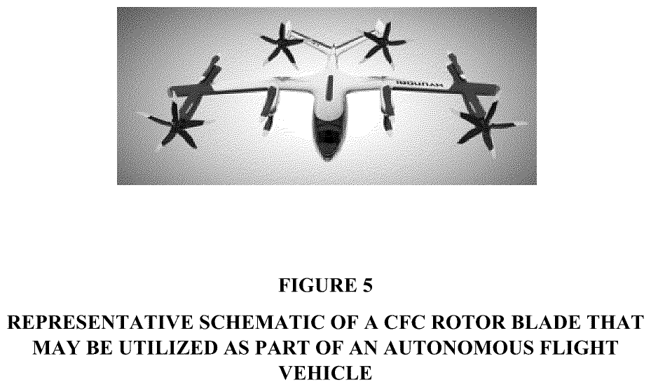

In a preferred embodiment, the CFC part employed in the methods of the present invention is a CFC rotor blade as shown in FIG. 5. The CFC rotor blade is designed to be connected to an autonomous drone. The methods and coating systems derived therefrom allow erosion resistant coating systems to be applied anywhere with precision and accuracy along the CFC surface that is susceptible to erosion degradation arising from exposure to an ambient environment containing water droplets and dust attacking the surfaces of the CFC rotor blades. In one example, the lead edge of the CFC rotor blade is deposited with the coating system of the present invention in accordance with the methods of the present invention. The advantage of the inventive approach versus conventional fitting of a fabricated metal sheath over the CFC rotor blade is that the present invention can be restricted to specific locations on the rotor with improved adhesion and less impact on weight. Additionally, the advantage of the inventive approach versus direct thermal spray methods is that the present invention can be applied at temperatures below 200 deg F., thereby eliminating concerns with damage of the CFC surface arising from high temperatures required to perform thermal spraying.

Applicants performed the test trial described hereinbelow to validate that the methods of the present invention can modify a CFC surface to create a nickel strike electrolytic layer and an overlying nickel electrolytic bondcoat onto which an erosion bondcoat can be deposited. The test trial is not intended to be construed as a limiting example, but rather illustrative of the principles of the present invention.

### Example 1 (Present Invention)

A CFC matrix test specimen was modified in accordance with the present invention. The surface of the CFC test specimen was activated. Activation was performed by grit blasting the surface of the CFC test specimen with 220 mesh aluminum oxide at 10 PSI in a pressure pot grit blast system. The result was a roughened surface. Applicants observed that the CFC test specimen was not damaged by the 10 psi of pressure imparted from the aluminum oxide grit particles.

The CFC test specimen was subsequently rinsed in deionized water for 1 minute followed by an acid soak in a 50 vol % solution, balance deionized water of a standard grade 33 vol % HCl at room temperature for 5 minutes to remove any impurities or grit blast residual debris remaining on the roughened surface. The acid soak pretreatment chemically reacted with the surface of the CFC test specimen to make the subsequently electrolytic nickel deposition more receptive to adherence.

The cleaned and acid pretreated CFC test specimen was then connected to a plating fixture utilized to perform the electroplating. In particular, the CFC test specimen was immersed into a nickel-plating electrolyte solution of 60 g nickel chloride per liter of the nickel-plating electrolyte solution and 120 ml of 33 wt % HCl per liter of the nickel-plating electrolyte solution. The bath was lightly agitated. The power source was a direct current rectifier. Titanium mesh anodes were immersed in the electrolyte solution. The titanium mesh anodes were connected to the positive side of the rectifier. The CFC test specimen was connected to the negative side of the rectifier. A potential difference of 3.3 V was created to generate 3.5 A of current. A current density of 65 A per square ft was produced. A flow of electrons occurred from the titanium mesh anodes to the surface of the CFC test specimen. Electrons at the surface reacted with positively charged nickel ions from the electrolyte solution to produce elemental nickel on the CFC test specimen. The electroplating occurred for about 20 minutes. No external heating was utilized. The temperature during the plating process was measured to be 72 deg F. The result was a relatively thin nickel strike electrolytic layer as shown in the photomicrograph of FIG. 2. No bare spots of the CFC test specimen were observed. The nickel strike electrolytic layer was sufficiently adhered to the CFC test specimen.

The CFC test specimen was removed from the above-mentioned plating fixture and then connected to a second plating fixture utilized to perform the electroplating of the nickel electrolytic bondcoat onto the nickel strike electrolytic layer. The CFC test specimen was immersed into a nickel-plating electrolyte solution of 400 g nickel sulfamate (Ni(NH2SO3)2) per liter of deionized water and 40 g boric acid per liter of deionized water. The bath was mildly agitated.

The power source was a direct current rectifier. Titanium mesh anodes were immersed in the electrolyte solution and were connected to the positive side of the rectifier. The CFC test specimen was connected to the negative side of the rectifier. A potential difference of 1.5 V was created to generate 1.0 A of current. A current density of 18.6 A per square ft was produced. A flow of electrons occurred from the titanium mesh anodes to the surface of the CFC test specimen. Electrons at the surface reacted with positively charged nickel ions from the electrolyte solution to produce elemental nickel on the CFC test specimen. External heating was utilized. The temperature during the plating process was measured to be about 40 deg C. The electroplating was performed for about 1 hour. The result was a relatively thicker nickel electrolytic bondcoat that was produced onto the nickel strike electrolytic layer, as shown in the photomicrograph of FIG. 2.

While it has been shown and described what is considered to be certain embodiments of the invention, it will, of course, be understood that various modifications and changes in form or detail can readily be made without departing from the spirit and scope of the invention. For example, while the preferred embodiment of the present invention pertains to CFC rotor blades, it should be understood that the methods of the present invention and coating systems derived therefrom can be appliable to any CFC substrate (e.g., non-rotating components) and any other type of non-conductive substrate besides PEEK. Additionally, while the embodiments have been described with regards to creation of a nickel strike electrolytic layer followed by a nickel electrolytic bondcoat, the present invention contemplates usage of other metals (e.g., copper, cobalt, chrome and metallic alloys) without departing from the spirit and scope of the present invention. It is, therefore, intended that this invention is not limited to the exact form and detail herein shown and described, nor to anything less than the whole of the invention herein disclosed and hereinafter claimed.

1. A method of modifying a carbon fiber composite (CFC) part to enable deposition of an erosion resistant coating system onto the CFC part, comprising:
providing the CFC part;
mechanically activating at least a portion of an exposed surface of the CFC part to create an activated surface;
immersing the activated surface of the CFC part into a first nickel-plating bath composition,
electroplating a nickel strike electrolytic layer onto the activated surface of the CFC part;
removing the CFC part from the first nickel-plating bath composition;
immersing the nickel strike electrolytic layer of the CFC part into a second nickel-plating bath composition; and
electroplating a nickel electrolytic bondcoat onto the nickel strike electrolytic layer of the CFC part.

2. The method claim 1, further comprising electroplating the nickel strike electrolytic layer at a first current density ranging from about 40 Amps per square foot and higher.

3. The method claim 1, further comprising electroplating the nickel electrolytic bondcoat at a second current density ranging from about 10 Amps per square foot and higher.

4. The method of claim 1, wherein the first nickel-plating bath composition comprises nickel chloride and hydrochloric acid.

5. The method of claim 1, wherein the second nickel-plating bath composition comprises Ni(NH2SO3)2 and boric acid.

6. The method of claim 1, wherein the mechanical activation comprises grit blast at 220 mesh aluminum oxide at about 7-10 PSI.

7. The method of claim 1, further comprising depositing an erosion resistant coating onto the nickel electrolytic bondcoat.

8. The method of claim 1, wherein the steps of electroplating the nickel strike electrolytic layer and electroplating the nickel electrolytic bondcoat is restricted to a specific location along the activated surface of the CFC part.

9. The method claim 8, wherein the CFC part is a rotor blade and the specific location is a lead edge of the rotor blade.

10. A method of modifying a carbon fiber composite (CFC) part to enable deposition of an erosion resistant coating system onto the CFC part, comprising:
providing the CFC part;
mechanically activating at least a portion of an exposed surface of the CFC part to create an activated surface;
immersing the activated surface of the CFC part into a nickel-plating bath composition; and
electroplating a nickel strike electrolytic layer onto the activated surface of the CFC part.

11. The method of claim 10, further comprising depositing a nickel electrolytic bondcoat onto the nickel strike electrolytic layer.

12. The method of claim 10, wherein the CFC part is a rotor blade comprising poly (ether-ketone-ketone).

13. The method of claim 10, wherein the modifying of the CFC part to enable deposition of the erosion resistant coating system onto the CFC part excludes depositing an electroless coating.

14. The method of claim 10, wherein the nickel-plating bath composition comprises nickel chloride and hydrochloric acid, said hydrochloric acid having a higher concentration in comparison to a concentration of the nickel chloride.

15. The method of claim 10, further comprising electroplating the nickel strike electrolytic layer at a temperature ranging from about 60 deg F. to about 80 deg F.

16. The method of claim 10, wherein the step of electroplating the nickel strike electrolytic layer comprises liberating an acid-containing gas at the exposed surface, said acid-containing gas removing one or more optional contaminant species adhered to the exposed surface prior to depositing the nickel strike electrolytic layer onto the exposed surface.

17. The method of claim 10, wherein the electroplating is performed without imparting external heating.

18. A modified carbon fiber composite (CFC) coated part, comprising:
a CFC part;
a nickel strike electrolytic layer on the CFC part; and
a nickel electrolytic bondcoat overlying the nickel strike electrolytic layer.

19. The modified CFC coated part of claim 18, wherein the nickel electrolytic bondcoat has a thickness that is greater than a thickness of the nickel strike electrolytic layer by a factor of about 4 or more.

20. The modified CFC coated part of claim 18, wherein a thickness of the nickel strike electrolytic layer is no greater than about 1 micron.

21. The modified CFC coated part of claim 18, wherein the CFC part is a rotor blade that is adapted to be operably connected to an autonomous drone.

22. The modified CFC coated part of claim 18, further comprising an erosion resistant coating over the nickel electrolytic bondcoat.

23. The modified CFC coated part of claim 18, said CFC coated part excluding an electroless coating.

24. The modified CFC coated part of claim 18, wherein the CFC part is a rotor blade, and further wherein the nickel strike electrolytic layer and the nickel electrolytic bond coat are selectively deposited onto a lead edge of the rotor blade.
